(19) United States
(12) Patent Application Publication
(10) Pub. No.: US 2019/0021155 A1
(43) Pub. Date: Jan. 17, 2019

(54) LIGHTING SCENE SELECTION BASED ON OPERATION OF ONE OR MORE INDIVIDUAL LIGHT SOURCES

(71) Applicant: PHILIPS LIGHTING HOLDING B.V., EINDHOVEN (NL)

(72) Inventors: BARTEL MARINUS VAN DE SLUIS, EINDHOVEN (NL); DIRK VALENTINUS RENÉ ENGELEN, HEUSDEN-ZOLDER (BE); BERENT WILLEM MEERBEEK, VELDHOVEN (NL)

(21) Appl. No.: 16/081,091

(22) PCT Filed: Feb. 22, 2017
(86) PCT No.: PCT/EP2017/054039

§ 371 Date: Aug. 30, 2018

Related U.S. Application Data
(60) Provisional application No. 62/302,498, filed on Mar. 2, 2016.

(30) Foreign Application Priority Data
Apr. 18, 2016 (EP) 16165704.4

(51) Int. Cl. H05B 37/02; H05B 33/08

(52) U.S. Cl. CPC H05B 37/0272; H05B 33/0842

(57) ABSTRACT

Various implementations described herein relate to selecting, based on user input to operate a particular light source, a lighting scene from a plurality of lighting scenes for implementation by a plurality of light sources. In some embodiments, a method may include detecting (502) user input provided to control light emitted by a first light source of the plurality of light sources; determining (504) one or more attributes of the user input; based on the one or more attributes of the user input, selecting (510) a first lighting scene from a plurality of lighting scenes implementable at least in part by multiple light sources of the plurality of light sources other than the first light source; and implementing (512) the selected lighting scene at least in part on two or more light sources of the plurality of light sources other than the first light source.

### TECHNICAL FIELD

The present invention is directed generally to lighting control. More particularly, various inventive methods and apparatus disclosed herein relate to selecting, based on user input to operate a particular light source, a lighting scene from a plurality of lighting scenes for implementation by a plurality of light sources.

### BACKGROUND

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

As lighting technology advances and more lighting units and luminaires are becoming networked, it is becoming more common for users to implement preconfigured “lighting scenes” across multiple light sources, rather than individually controlling each light source in turn to achieve the desired overall effect. Networked luminaires and/or lighting units may be controlled with mobile computing devices such as smart phones, tablet computers and/or wearable computing devices such as smart glasses, smart watches, and so forth. However, a user may not always have her mobile computing devices handy when she wishes to select and/or implement a lighting scene across a plurality of light sources. Indeed, even though users are more commonly implementing relatively complex lighting scenes across multiple light sources, the users still desire that control be simple and performable at relatively few locations, such as using a wall switch or operating a luminaire. Thus, there is a need in the art to leverage the communication capabilities of lighting units and/or luminaires to perform simplified lighting control.

### SUMMARY

The present disclosure is directed to inventive methods and apparatus for selecting, based on user input to operate a particular light source, a lighting scene from a plurality of lighting scenes for implementation by a plurality of light sources. For example, a user may operate a single light source (e.g., using a wall switch or by manipulating controls on a luminaire) to cause that light source to emit a desired light effect. At the same time, other light sources (e.g., in the same room or nearby) may also be triggered to each emit light that forms a respective portion of an overall desired lighting scene.

Generally, in one aspect, a method for controlling a plurality of light sources may include: detecting user input provided to control light emitted by a first light source of the plurality of light sources; determining one or more attributes of the user input;

Based on the one or more attributes of the user input, selecting a first lighting scene from a plurality of lighting scenes implementable at least in part by multiple light sources of the plurality of light sources other than the first light source; and implementing the selected lighting scene at least in part on two or more light sources of the plurality of light sources other than the first light source. In some embodiments, the method may further include determining a context in which the user input is detected. In some such embodiments, electing the first lighting scene from the plurality of lighting scenes may be further based on the context in which the user input is detected. In some versions, the context may include a time of day at which the user input was provided.

In some embodiments, the method may further include determining one or more attributes of the first light source, and selecting the first lighting scene from the plurality of lighting scenes may be further based on the one or more attributes of the first light source. In some versions, the one or more attributes of the first light source comprise a purpose for which the first light source is intended. In some versions, the one or more attributes of the first light source may include an identifier associated with the first light source. In some embodiments, the identifier distinguishes the first light source among the plurality of light sources.

In some embodiments, the plurality of light sources are linearly disposed on a linear LED array. In some embodiments, the method may further include communicating the one or more attributes of the user input to the plurality of light sources over one or more networks. In some embodiments, the method may further include communicating the selected first lighting scene from a plurality of lighting scenes to the plurality of light sources over one or more networks.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

A “lighting control action” may be an instruction or command to emit light having a particular lighting property. For example, a lighting control action may cause a lighting unit or luminaire in which a lighting unit is installed to alter a property of light it emits, such as hue, saturation, brightness/intensity, temperature, dynamic sequence, and so forth. A lighting control action may also cause a lighting unit or luminaire in which a lighting unit is installed to turn on or off, to begin/end a dynamic lighting sequence, to emit light forming a respective part of a predetermined lighting scene (e.g., romantic, relaxing, naptime, etc.), and so forth.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates one example of how operation of a particular light source may be configured to trigger initiation of a lighting scene involving a plurality of light sources, in accordance with various embodiments.

FIG. 2 schematically depicts components of an example luminaire configured with selected aspects of the present disclosure, in accordance with various embodiments.

FIG. 3 illustrates an example of how a particular light source may cause initiation of multiple different lighting scenes, in accordance with various embodiments.

FIG. 4 illustrates an example user interface that may facilitate configuration of lighting scenes to be implemented by a plurality of light sources in response to user operation of individual light sources, in accordance with various embodiments.

FIG. 5 depicts an example method of configuring a lighting unit or luminaire to cause initiation of one or more lighting scenes, in accordance with various embodiments.

FIG. 6 depicts another example lighting system configured with selected aspects of the present disclosure, in accordance with various embodiments.

### DETAILED DESCRIPTION

It is becoming more common for users to implement preconfigured “lighting scenes” across multiple light sources, rather than individually controlling each light source in turn to achieve the desired overall effect. However, implementing such lighting scenes using a mobile computing device may not always be convenient, and users may prefer to implement lighting scenes across multiple light sources using the same controls they have used historically, such as wall switches and/or manipulable elements of luminaires. Thus, there is a need in the art to leverage the communication capabilities of lighting units and/or luminaires to perform simplified lighting control. In view of the foregoing, various embodiments and implementations of the present invention are directed to methods, apparatus and systems for selecting, based on one or more attributes or user input provided to operate a particular light source, a lighting scene from a plurality of lighting scenes for implementation by a plurality of light sources.

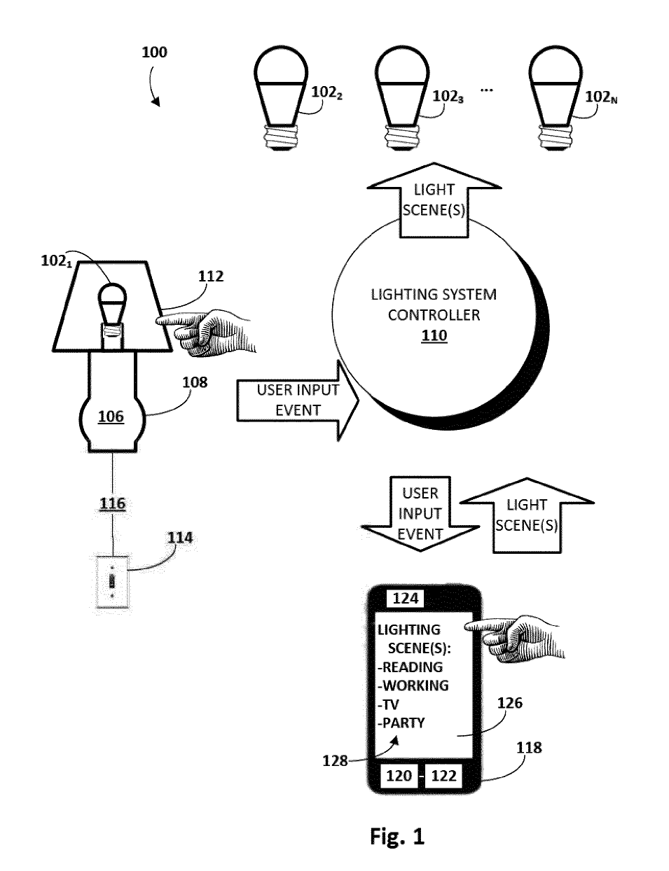

Referring to FIG. 1, in one embodiment, a lighting system 100 may include a plurality of lighting units 102_{1-N} and a lighting system controller 110. Lighting units 102 may come in various forms, and may include various types of light sources, such as LEDs, incandescent lights, halogen lights, fluorescent lights, and so forth. A lighting unit 102₁ is depicted installed in a luminaire 106 that takes the form of a lamp having an outer surface 108 and a lampshade 112. The other lighting units 102_{2-N} are schematically depicted in isolation, but would likely also be installed in luminaires (not depicted), such as in ceiling or wall lighting fixtures, other table lamps, standup lamps, and so forth.

Lighting system controller 110 may be in network communication with one or more luminaires and/or lighting units, such as lighting units 102_{1-N} and/or luminaire 106. In various embodiments, lighting system controller 110 may communicate with luminaires and/or lighting units using various wireless and wired mediums, as well as various communication technologies, including but not limited to Wi-Fi, Ethernet, ZigBee, coded light, radio frequency (“RF”), and so forth. In various embodiments, luminaires and/or lighting units may likewise be configured to communicate with lighting system controller 110 and/or each other using similar mediums and technologies.

In various embodiments, luminaire 106 (or any other lighting fixture or lighting unit 102 installed therein) may be operated in accordance with user input provided by a user in various ways. In a most typical example, a user may operate a user interface that is integral with luminaire 106. For example, a user may pull a string or flip a switch on luminaire 106 to cause electricity to be provided to lighting unit 102₁, e.g., from mains. Additionally or alternatively, in some embodiments, a wall switch 114 may be communicatively coupled with luminaire 106 and may be operable to control light emitted by lighting unit 102₁. In some embodiments, wall switch 114 may be electrically coupled with luminaire 106 via one or more wires 116. In other embodiments, wall switch 114 may be a wireless switch that communicates with one or more lighting units 102, e.g., directly or indirectly via lighting system controller 110. In yet other embodiments, outer surface 108 and/or lampshade 112 may be touch-sensitive, such that a user may touch them in order to operate luminaire 106 to emit light having various selected properties.

In various embodiments, a user may be able to communicate with and/or operate lighting system controller 110, luminaire 106 and/or one or more lighting units 102 using a computing device such as a mobile computing device 118. Mobile computing device 118 may come in various forms, such as a smart phone, tablet computer, wearable computer (e.g., smart glasses, smart watches, etc.), laptop computer, and so forth. Mobile computing device 118 may include various types of input and/or output devices, such as a touch screen 126.

Mobile computing device 118 may also include one or more processors 120 and memory 122 (e.g., RAM, ROM, flash, etc.) storing instructions that, when executed by one or more processors 120, cause one or more processors 120 to perform selected aspects of the present disclosure. Mobile computing device 118 may also include one or more wireless interfaces 124, which may enable communication using various technologies, including but not limited to Wi-Fi, radio frequency, Bluetooth, NFC, ZigBee, coded light, cellular, and so forth. It will be understood that, as a networked computing device, lighting system controller 110 may also include components such as processors, memory, wireless interfaces, and so forth.

In various embodiments, a user may operate mobile computing device 118 to configure lighting system controller 110, one or more lighting units 102, and/or luminaire 106, to perform various actions in response to detection of user input provided to control one or more properties of light emitted by a particular lighting unit 102. Later, when similar user input is provided to control the same lighting unit 102, the operated lighting unit 102 may emit light (e.g., energize one or more LEDs). Meanwhile, based at least in part on one or more attributes of the user input, a lighting scene may be selected for implementation by one or more other lighting units 102 of lighting system 100.

FIG. 1 depicts one example of how luminaire 106, and more particularly, lighting unit 102₁, may be configured to trigger implementation of a selected lighting scene by lighting units 102_{2-N}, in accordance with various embodiments. A user may provide input to operate luminaire 106, e.g., by operating wall switch 114, touching outer surface 108 and/or lampshade 112, etc. Data indicative of the user input event may be transmitted from luminaire 106 and/or lighting unit 102₁ to lighting system controller 110. Lighting system controller 110 may in turn transmit the data to mobile computing device 118. Mobile computing device 118 may render, e.g., on touch screen 126, a user interface 128. In various embodiments, user interface 128 may be associated with an application (or “app”) operating on mobile computing device 118 that enables a user to control one or more luminaires 106 and/or lighting units 102 forming lighting system 100. In various embodiments, user interface 128 may be operable by a user (e.g., as a drop down list) to select a particular predetermined lighting scene that is to be initiated in response to future user input provided to operate lighting unit 102₁ that correspond to the just-received user input data. When similar user input is provided at lighting unit 102₁ later, lighting system controller 110 may provide light scene data and/or one or more lighting control actions to lighting units 102_{2-N}.

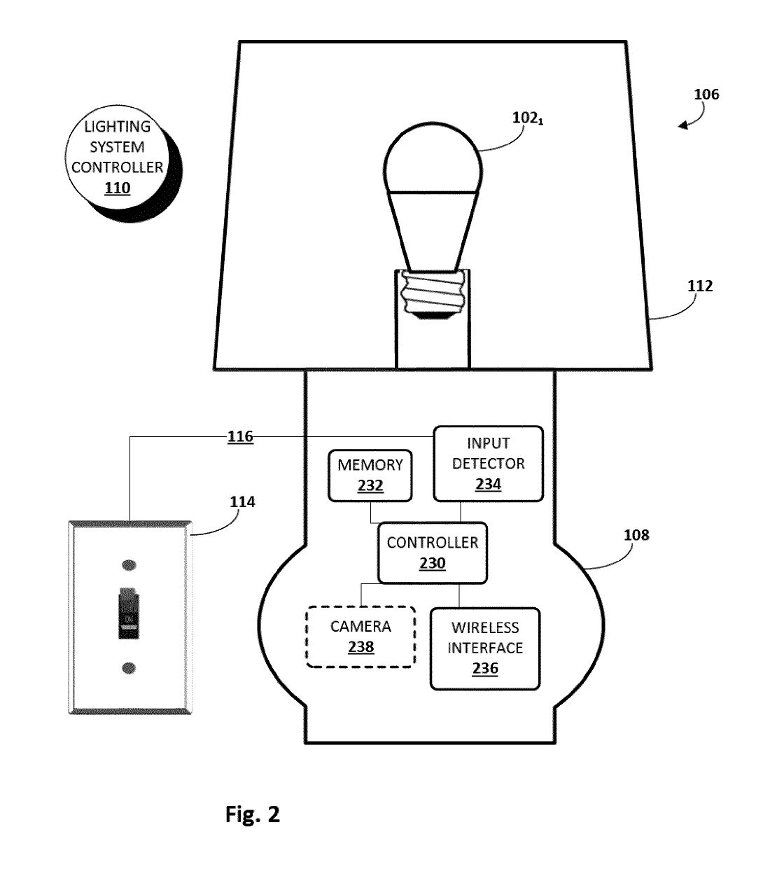

FIG. 2 schematically depicts example components that may be incorporated into a luminaire such as luminaire 106, or even into a lighting unit 102, in order to facilitate performance of selected aspects of the present disclosure. A controller 230 is depicted operably coupled with memory 232, an input detector 234, a wireless communication interface 236 and, optionally, a camera 238. Memory 232 may come in various forms, including but not limited to RAM, ROM, flash memory, and so forth. Memory 232 may include instructions that when executed by controller 230, cause controller 230 to perform selected operations of the present disclosure.

Input detector 234 may detect and provide one or more signals indicative of user input provided to operate lighting unit 102₁. Input detector 234 may come in various forms. In some embodiments, input detector 234 may be configured to detect actuation of a button, string, or other user-operated mechanical mechanism that is integral with luminaire 106 (or with lighting unit 102₁ in some cases) to operate lighting unit 102₁. In some embodiments, input detector 234 may include an accelerometer that is configured to sense forces or movements of luminaire 106caused by a user providing touch control input. In various embodiments, such an input detector may be installed in luminaire 106 or in lighting unit 102₁. In some embodiments, input detector 234 may be configured to detect and provide a signal indicative of operation of wall switch 114 to control light emitted by lighting unit 102₁.

Wireless communication interface 236 may allow controller 230 to exchange data through various wireless mediums with remote computing devices, such as lighting system controller 110 and/or mobile computing device 118 of FIG. 1. Wireless communication interface 236 may come in various forms. In some embodiments, wireless communication interface 236 may communicate with remote computing devices directly or indirectly (e.g., through a local wireless network) using technologies such as BlueTooth, ZigBee, coded light, Wi-Fi, RFID, near field communication (“NFC”), and so forth. In some embodiments, wireless communication interface 236 may be configured to communicate with a remote computing device using technology described in the IEEE 802.15 standards (Wireless Personal Area Networks, or “WPAN”), including but not limited to visible light communication (802.15.7) and/or body area networks (802.15.6). In some embodiments where coded light is used to exchange data, camera 228 may act as a de facto wireless communication interface 236. Although only a single wireless communication interface 236 is depicted in FIG. 2, this is not meant to be limiting. In various embodiments, luminaire 106 (or in some cases, installed lighting unit 102₁) may include more than one wireless communication interface, and additionally may include one or more wired communication interfaces (not depicted in FIG. 2). For example, a single luminaire 106 may include a ZigBee interface, an NFC interface and/or a coded light interface.

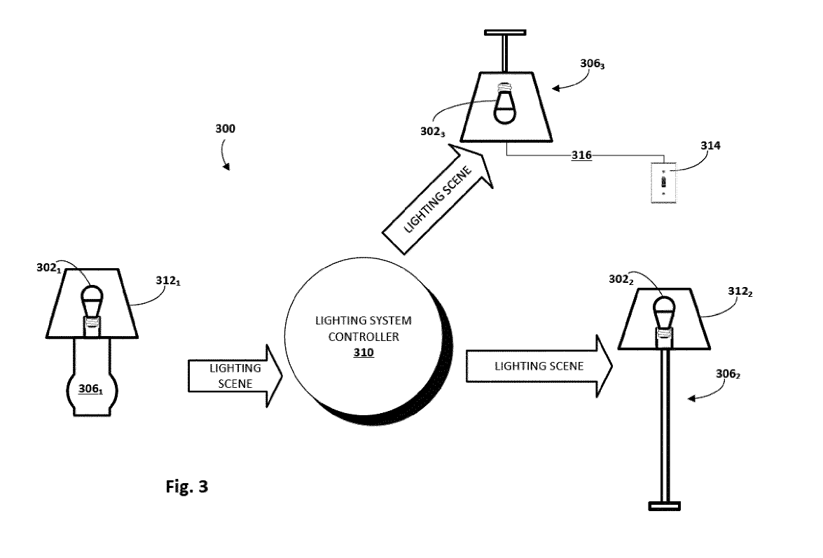

FIG. 3 depicts an example of how user operation of one lighting unit or luminaire may cause selection and implementation of a lighting scene by one or more additional lighting units and/or luminaires, in accordance with various embodiments. In FIG. 3, a lighting system 300 includes a lighting system controller 310 that is communicatively coupled with a first luminaire 306₁ in the form of a table lamp with a first lighting unit 302₁, a second luminaire 306₂ in the form of a standup lamp with a second lighting unit 302₂ installed, and a third luminaire 306₃ in the form of a ceiling-mounted luminaire with a third lighting unit 302₃ installed.

In this example, a user has provided input to operate first luminaire 306₁ and/or first lighting unit 302₁, e.g., by touching lampshade 312₁. In response, luminaire 306₁ and/or first lighting unit 302₁ may detect one or more attributes of the provided user input, and may select a predetermine lighting scene for implementation by multiple lighting units, in this case 302₁₋₃. Various attributes of user input may be used to select a predetermined lighting scene. In examples such as that depicted in FIG. 3 in which touch is used to control light output, a number of touch or tap actions are provided, a number of fingers used to provide touch, how forcibly touch is provided, a duration of the touch, a location on the luminaire/lampshade/lighting unit that is touched, etc., may be considered when selecting a lighting scene.

Other types of user inputs provided to control light output of a lighting unit and/or luminaire may have other attributes that may be used to select lighting scenes to implement. For example, in some embodiments, the simple fact that a user operated a lighting unit and/or luminaire may constitute an attribute of user input. Thus, the fact that a user flips a wall switch or pulls a string on a lamp to turn the lamp on or off may be used to select a lighting scene from a plurality of lighting scenes for implementation by other lighting units and/or luminaries. In some embodiments, lighting units and/or luminaires are controllable using more advanced wall switches, such as dimming switches and/or so-called “smart” switches with more robust capabilities (e.g., enabled by capacitive touch surfaces). In such embodiments, one or more attributes of how the dimming and/or smart switch is operated (e.g., how much dimmed, how quickly dimmed, double tap, pinch, swipe, etc.) may be considered when selecting a lighting scene.

In some embodiments, lighting units and/or luminaires are controllable using gestures. In such embodiments, a duration of a gesture, a location of a gesture, a sequence of movements in a gesture, a shape made with a gesture, and so forth, may be considered when selecting a lighting scene. In some embodiments, lighting units and/or luminaires are controllable using external computing devices. In some such embodiments, a type of device (e.g., smart phones, tablets, smart watches, etc.), a type of input component at which the input was provided (e.g., touch screen, microphone, smart button, etc.), one or more attributes of the input (e.g., double tap, sound profile, turning of a dial, words or characters spoken or typed, swipe, pinch, etc.), a type of network communication to the lighting unit/luminaire (e.g., ZigBee, Wi-Fi, Bluetooth, infrared, etc.), and so forth, may be considered when selecting a lighting scene.

A lighting scene to be implemented by a plurality of lighting units and/or luminaires may additionally or alternatively be selected based on other signals or cues. For example, in some embodiments, a lighting scene may be selected based on one or more attributes of a lighting unit or luminaire that is being operated by a user, such as a “type” associated with a lighting unit or luminaire. Suppose a particular luminaire is designated as a “reading” unit (e.g., at the factory when the lamp is sold as a desk lamp). When that unit is operated, a lighting scene associated with “reading” (e.g., subdued, soft intensity) may be more likely selected (or at least recommended). As another example, suppose a particular luminaire or lighting unit is designated as a “party” unit (e.g., a black light or disco-ball based unit). When that unit is operated, a lighting scene associated with “partying” (e.g., animating lighting, colored lighting, dynamic lighting, etc.) may be more likely selected.

Or, as a simpler example, suppose a single light source is part of a lighting system that includes a plurality of light sources which may or may not be homogenous (e.g., light tape or rope that includes a plurality of LEDs arranged in a linear fashion). Each light source of the plurality of light sources may have a unique identifier at least among that plurality of light sources. Additionally, each light source (or sets of light sources such as n adjacent light sources) may be associated with one or lighting scenes implementable by the entire plurality of light sources. Using techniques described herein, a user may operate a particular light source (e.g., by touching it, pressing it, etc.) to cause at least some other light sources of the plurality of light sources to implement respective portions of a lighting scene associated with the particular light source. The user may operate a different light source to cause a different lighting scene to be implemented. Thus, for instance, a user could slide a finger along the light tape to toggle through multiple light scenes implemented by the entire lighting tape, e.g., from warm white light to cool white light.

As another example, when selecting a lighting scene, one or more attributes of a “context” in which input is provided and/or detected to operate a particular lighting unit or luminaire may be considered. A context in which input is provided may have various attributes, such as time of day, location, operator identity, already-implemented lighting scene, etc. For example, if a given unit is operated in the morning, then lighting scenes associated with morning illumination (e.g., “wake up,” “breakfast,” etc.) may be more likely selected. If the same unit is operated in the evening, then different lighting scenes associated with evening illumination (e.g., “dinner,” “watching television”) may be more likely selected.

In various embodiments, the fact that a particular lighting scene is already implemented—on the same light sources that are under consideration for implementation of a new lighting scene or by a related group of light sources—may have bearing on which lighting scene is selected. For example, suppose light sources in a first room are already implementing a “holiday” lighting scene, and that a user turns on a light source in an adjacent room. Under normal circumstances, the lighting scene selected for the adjacent room may be selected based on one or more attributes of how the user operated the light source, etc. However, given that the “holiday” lighting scene is being implemented in the first room, a similar “holiday” lighting scene may be more likely selected for the adjacent room. This selection may be bolstered, for example, by an online calendar or emails associated with the user that suggest the user is hosting a holiday party in his or her home.

Referring back to FIG. 3, once luminaire 306₁ and/or lighting unit 302₁ selects a lighting scene, data indicative of that lighting scene may be communicated to lighting system controller 310. Lighting system controller 310 in turn may provide the same data (or other similar data such as lighting control commands) to other lighting units and/or luminaires, such as luminaire 306₂, lighting unit 302₂, luminaire 306₃, and/or lighting unit 302₃. This may cause the other lighting units and/or luminaires to implement the lighting scene. In this example, first lighting unit 302₁ and/or luminaire 306₁ selected the lighting scene. However, in other embodiments, first lighting unit 302₁ and/or luminaire 306₁ may simply forward data indicative of provided user input, context in which input was received, and/or data about themselves to lighting system controller 310. Lighting system controller 310 may then select a lighting scene, and may cause other lighting units and/or luminaires to implement the lighting scene.

Of course, the example depicted in FIG. 3 only depicts a one-way example of what happens when first luminaire 306₁ and/or lighting unit 302₁ is operated. If other light sources in system 300, such as lighting unit 302₂, luminaire 306₂, lighting unit 302₃, and/or luminaire 306₃, are operated, that may cause the same or different lighting scenes to be implemented in the various light sources of system 300. For example, operation of first lighting unit 302₁ may cause implementation of a “cozy” lighting scene across system 300, whereas operation of second lighting unit 302₂ may cause implementation of a “cooking” lighting scene across system 300, and operation of third lighting unit 302₃ may cause implementation of a “reading” lighting scene across system 300.

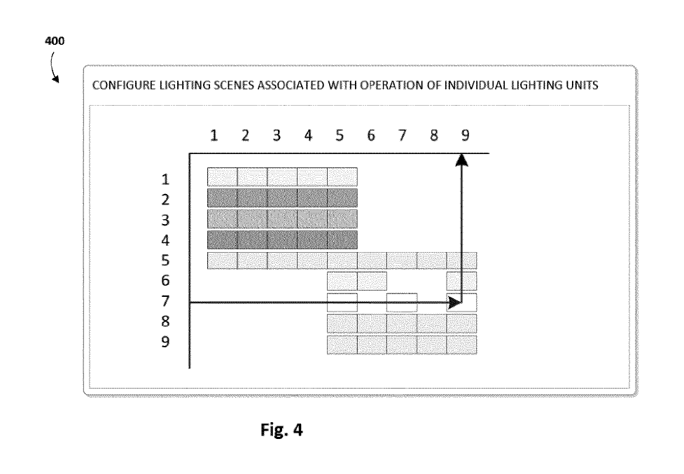

FIG. 4 depicts an example graphical user interface 400 that may be rendered on a computing device such as mobile computing device 118 in FIG. 1 in order to enable a user to configure lighting scenes to be implemented on activation of selected light sources. In this example, there are nine possible light sources, 1-9. As depicted by the arrows, operation of light source 7 is tied to operation of light sources 5 and 9, such that when light source 7 is activated, light sources 5 and 9 are activated as well, forming a de facto lighting scene. The remaining light sources (i.e., 1-4, 6, 8) are not activated in response to activation of light source 7, but if a user so chooses, she may select any of these other light sources for activation, e.g., by selecting a space (e.g., on a touch screen or using a mouse) that corresponds to the desired light source.

Additionally, the user may select one or more properties of light to be emitted by each light source. In this example, when light source 7 is activated to emit white light, light sources 5 and 9 also emit white light, forming a relatively uniform lighting scene. By contrast, when light source 4 is activated at a particular intensity (represented by the relatively dark gray tone), light sources 2-5 are also activated at similar intensities. When light source 9 is activated at an intermediate intensity (represented by an intermediate gray tone), light sources 5-8 are also activated at similar intensities.

In addition to manually configuring lighting scenes associated with operation of individual light sources, in some embodiments, lighting scenes may be “learned” based on user behavior. For example, when user input is provided to operate a particular light source, a timer may start, and for some preset time interval, additional activity of the user may be monitored. Suppose the user operates other light sources in the vicinity to create an ad hoc lighting scene. The system may detect these light settings, as well as the user input at the particular light source and any applicable contextual attributes, and may automatically associate the user-created light scene with operation of the particular light source.

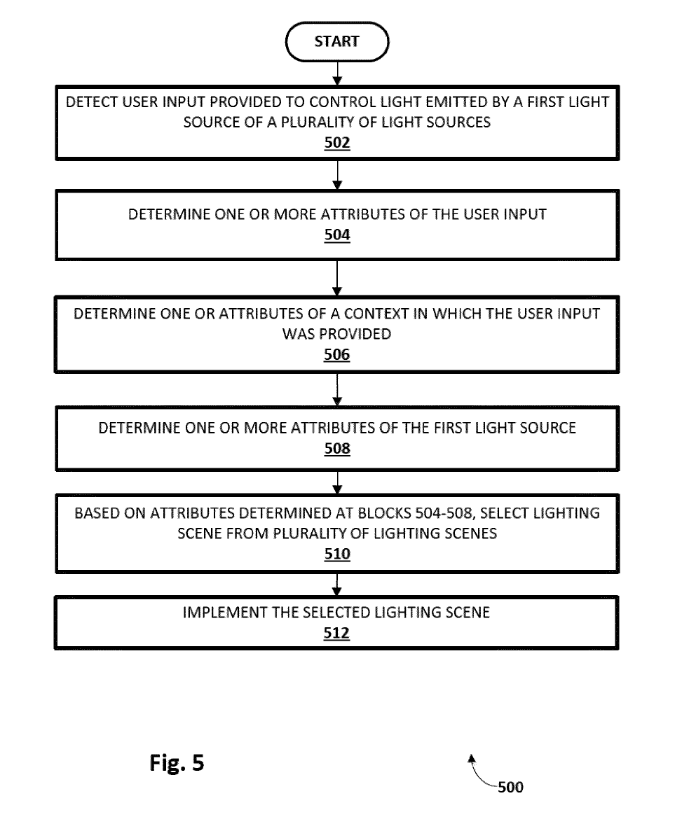

FIG. 5 schematically depicts an example method 500 for control light emitted by one or more light sources of a lighting system using disclosed techniques, in accordance with various embodiments. At block 502, user input provided to control light emitted by a particular light source of a plurality of light sources may be detected. As discussed above, this input may be provided in various forms, such as a user operating a light switch, a dimmer, a capacitive touch surface, a touch screen (e.g., of a mobile phone or smart watch), an audio-based input (e.g., a clapper or voice command), and/or or a touch-sensitive surface of a lighting unit and/or luminaire. In some embodiments, the user input may be a gesture sensed by, for instance, a camera or infrared sensor associated with a lighting unit or luminaire. In some embodiments, the user input may be the user gazing at a particular lighting unit or luminaire. In some embodiments, the user input may be passive, such as motion/proximity/presence captured by a motion sensor (e.g., passive infrared), a user's weight captured on a pressure pad as the user walks by, and so forth.

At block 504, one or more attributes of the user input may be determined. As noted above, various components may make these determinations. For example, in some embodiments, a lighting unit or luminaire may include logic such as a controller that identifies various attributes of the user input. In other embodiments, the lighting unit or luminaire may simply provide data indicative of the input to another component, such as a lighting system controller, and the lighting system controller may determine the one or more attributes of the user input. Attributes of user input may include a variety of data points, such as a component at which input was provided (e.g., at a dimmer switch versus at a regular light switch versus operation of a touch-sensitive surface of a lamp versus light control using a mobile device), how the input was provided (e.g., swipe, double tap, pinch, etc.), a magnitude of the input (e.g., how much a dimmer switch was moved, how much a user pinched a touch screen, how forcibly a user tapped a touch-sensitive lamp, etc.), a gesture made by the user as input, and so forth.

At block 506, one or more attributes of a context in which the user input was provided may be determined, e.g., at a lighting unit or luminaire itself or at a central component such as a lighting system controller. Example contextual attributes are described above, and may include data points such as a time at which a light source was operated, whether a lighting scene is already implemented nearby, and so forth. Additionally or alternatively, a context in which user input was provided may include one or more attributes of the user that provided the input. Thus, as a simple example, one lighting scene may be implemented when a first user operates a given light source, and another lighting scene may be implemented when a second user operates the same given light source. Thus, in some embodiments, a lighting scene may be selected based at least in part on an identity of a user who provides input to operate a particular light source.

At block 508, one or more attributes of the light source being operated may be determined, e.g., at a lighting unit or luminaire itself or at a central component such as a lighting system controller. These may include, for instance, a “type” of light source (e.g., “reading luminaire,” “patio light,” etc.), a unique identifier of a light source, and so forth.

Based on the data obtained at one or more of blocks 504-508, at block 510, a lighting scene may be selected from a plurality of lighting scenes, e.g., by a lighting unit or luminaire itself or by a central component such as a lighting system controller. For example, a lighting system controller may receive or otherwise ascertain one or more of the data points determined at blocks 504-508 and use these data points to select a lighting scene to be implemented at least in part on light sources of the lighting system other than the light source that was operated directly by the user. At block 512, the lighting scene selected at block 510 may be implemented on a plurality of light sources, which may or may not include the light source operated by the user.

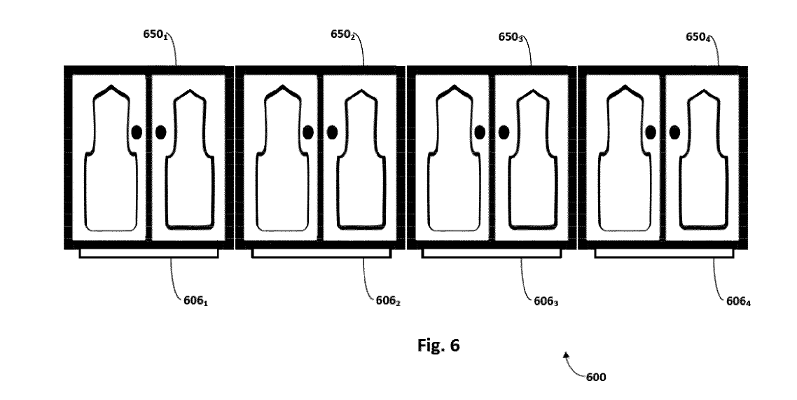

FIG. 6 depicts another example lighting system 600 that includes lighting units 606₁₋₄ in the form of under-cabinet down lighting units that are secured to the undersides of cabinets 650₁₋₄. The lighting units 606₁₋₄ may be touch operated in this example, e.g., by way of one or more capacitive touch surfaces. For example, there may be a capacitive ring around a perimeter of each lighting unit. Each of lighting units 606₁₋₄ may be associated with one or more lighting scenes that may be implemented by all, or at least more than one, lighting unit 606. For example, if a user touches lighting unit 606₁, then one lighting scene (e.g., “cooking”) may be implemented by two or more of lighting units 606₁₋₄. If user touches lighting unit 606₂, another lighting scene (e.g., “having coffee”) may be implemented by two or more of lighting units 606₁₋₄. Yet other lighting scenes may be implemented if the user touches lighting unit 606₃ or 606₄.

As alluded to above, in various some embodiments, a single lighting unit or luminaire may be associated with multiple lighting scenes. Which of those lighting scenes is selected may depend on, for instance, one or more attributes of the user input, context, etc. However, it may also be possible for a user to see all lighting scenes associated with a lighting unit, e.g., by toggling through each lighting scene by operating the lighting unit in various ways. For example, a user could tap a touch-sensitive luminaire multiple times, each time causing another lighting scene associated with the luminaire to be implemented by a plurality of lighting units and/or luminaires. When a desired lighting scene is implemented, the user can stop tapping, and in some cases may provide a unique input (e.g., double tap, pinch, clap, swipe, etc.) that thereafter may be used by the user as a “shortcut” to the selected lighting scene.

With some types of input it may not be immediately apparent which light source is being controlled, and hence it may be difficult to select a lighting scene. For example, suppose a user provides voice input to operate a particular lighting unit, but multiple voice-controllable lighting units are in the vicinity. A determination may need to be made as to which lighting unit was being operated. In some such embodiments, the voice input as received at each lighting unit (e.g., represented as a waveform) may be compared to the voice input as received at other lighting units to determine which lighting unit is nearest the speaker (e.g., which waveform demonstrates the highest detected volume), and thus should be controlled by the provided voice input.

Light sources such as lighting units and luminaires are largely described herein as being members of a larger groups that can collectively implement lighting scenes. But it should be understood that a single lighting unit or luminaire may be a member of multiple groups. Moreover, based on attributes of user input/context, operation of that lighting unit or luminaire may cause implementation of different lighting scenes on different groups of lighting units. For example, suppose a hallway lies between a kitchen and a dining room. A hallway light may be operated in one way to trigger implementation of a cooking lighting scene on lights in the kitchen. The same hallway light may be operated in another way to trigger implementation of a dining scene on lights in the dining room. And of course the hallway light itself may emit a respective portion of either lighting scene.

As noted above, a context in which a lighting unit or luminaire is operated may include one or more attributes of a user that is operating it, and those one or more attributes of the user may be used to select lighting scenes. In embodiments that consider attributes of the user when selecting lighting scenes, the identity of the user may be determined in various ways. In some embodiments, the user may carry a computing device such as a smart phone or smart watch that emits some sort of identifier signal that is detected by a lighting unit/luminaire and/or by a lighting system controller. In other such embodiments, one or more physical characteristics of the user, such as size, voice profile, height, finger size, an identifying gesture or pattern associated with a particular user, etc., may be detected and used to determine the user's identity.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A method for controlling a plurality of light sources, comprising:
detecting user input provided to control light emitted by a first light source of the plurality of light sources;
determining one or more attributes of the user input;
determining a context in which the user input is detected, the context comprising a time of day at which the user input was provided, location, operator identity or already-implemented lighting scene;
based on the one or more attributes of the user input, selecting a first lighting scene from a plurality of lighting scenes implementable at least in part by multiple light sources of the plurality of light sources other than the first light source, the selecting being based at least on the context in which the user input is detected; and
implementing the selected lighting scene at least in part on two or more light sources of the plurality of light sources other than the first light source.

2. The method of claim 1, further comprising:
determining one or more attributes of the first light source;
wherein selecting the first lighting scene from the plurality of lighting scenes is further based on the one or more attributes of the first light source.

3. The method of claim 2, wherein the one or more attributes of the first light source comprise a purpose for which the first light source is intended.

4. The method of claim 2, wherein the one or more attributes of the first light source comprise an identifier associated with the first light source.

5. The method of claim 4, wherein the identifier distinguishes the first light source among the plurality of light sources.

6. The method of claim 1, wherein the plurality of light sources are linearly disposed on a linear LED array.

7. The method of claim 1, further comprising communicating the one or more attributes of the user input to the plurality of light sources over one or more networks.

8. The method of claim 1, further comprising communicating the selected first lighting scene from a plurality of lighting scenes to the plurality of light sources over one or more networks.

9. A lighting system, comprising:
a plurality of light sources;
a controller communicatively coupled with the plurality of light sources, the controller being configured to:
receive an indication of user input provided to control light emitted by a first light source of the plurality of light sources;
determine one or more attributes of the first light source;
determine a context associated with the user input, the context comprising a time of day at which the user input was provided, location, operator identity or already-implemented lighting scene;
based on the one or more attributes of the first light source, select a first lighting scene from a plurality of lighting scenes implementable at least in part by multiple light sources of the plurality of light sources other than the first light source, the selecting being based at least on the context associated with the user input; and
instruct two or more light sources of the plurality of light sources to implement respective portions of the selected lighting scene.

10. The system of claim 9, wherein the controller is communicatively coupled with the plurality of light sources over one or more busses.

11. The system of claim 9, wherein the controller is communicatively coupled with the plurality of light sources over one or more networks.

12. The system of claim 9, wherein the controller is further configured to determine a context in which the user input is detected, wherein selection of the first lighting scene from the plurality of lighting scenes is further based on the context in which the user input is provided.

13. A lighting unit, comprising:
one or more light sources;
a wireless communication interface; and
a controller operably coupled with the wireless communication interface, the controller being configured to:
detect user input provided to control light emitted by the light source;
determine one or more attributes of the user input;
determine a context in which the user input is detected, the context comprising a time of day at which the user input was provided, location, operator identity or already-implemented lighting scene;
based on the one or more attributes of the user input, select a first lighting scene from a plurality of lighting scenes implementable at least in part by the first light source, the selecting being based at least on the context in which the user input is detected;
operate the light source to implement at least part of the selected lighting scene;
transmit, via the wireless communication interface to one or more remote lighting units, data indicative of the selected lighting scene or the one or more attributes of the user input, whereby the one or more remote lighting units implement respective portions of the lighting scene.
